(19) United States
(12) Patent Application Publication
(10) Pub. No.: US 2003/0154104 A1
(43) Pub. Date: Aug. 14, 2003

(54) Method of operating a savings plan for health care services

(76) Inventor: Alvin Koningsberg, Brooklyn, NY (US)

Correspondence Address: Steven Horowitz, Counselor At Law, Suite 700, 295 Madison Avenue, New York, NY, 10017, US

(21) Appl. No.: 10/307,166

(22) Filed: Nov. 29, 2002

Related U.S. Application Data
(63) Continuation-in-part of application No. 10/075,033, filed on Feb. 12, 2002.

(51) Int. Cl. G06F 17/60

(52) U.S. Cl. 705/2; 705/40

(57) ABSTRACT

A health care services savings plan highlights a savings. Data is entered, published and updated on the plan owner's advertised web site identifying provider entities per specialty, their regular and discounted price for each treatment type and the service fee percentage charged by the plan. Users access the data, select health care provider, present plan cards to the selected entities and receive health care. The plan bills the user the regular price, issues a credit for the savings difference and bills separately for the administrative, charge debit calculated by applying published service fee percentage of between twenty-five and thirty-three percent to the savings difference. Electronic billing triggered when the health care provider bills the plan by computer and the plan electronically bills the consumer's credit card. A prescription patient profile database is maintained and updated by a data source including information about all prescription medication of the health care consumer.

This patent application is filed pursuant to 37 CFR 1.53(b) as a continuation-in-part patent application of U.S. patent application Ser. No. 10/075,033, which was filed on Feb. 11, 2002 and which is presently pending.

### FIELD OF THE INVENTION

The field of this invention is methods for the provision of health care services and more particularly such methods that are savings plans in which a patient profile of medication is maintained as part of the plan.

### BACKGROUND OF THE INVENTION

Finding a competent health care provider at a discounted price can be difficult. Existing services or networks make referrals to providers willing to accept a discounted price in return for their listing in the network. However, these services typically charge a monthly fee to the consumer. This means that even if a consumer of health care services goes to the doctor relatively infrequently, he or she pays that monthly premium. This makes such a system unattractive.

Another drawback to existing savings plans is the lack of a benefit seen by the consumer at the time of joining the plan as well as during the time of use of the plan. In order for the savings plan to work it has to attract a large pool of providers and a large pool of consumers and it has to maintain the participation of these pools after an initial use of the plan. In order to attract and maintain a large pool of consumers, the consumers have to feel the benefits of participating in a savings plan. Existing plans advertise the number of providers that participate in the plan, the amount of the discount off a hypothetical regular price or fee, the inclusiveness of the plan with respect to the type of health care services available to be covered by the plan, the inclusion of particular treatments in the plan, and the fact that it is easy to join and use the plan. Existing plans do not, however, advertise that there is no monthly fee, since the plans need to recoup their administrative expenses of operating the plan.

With respect to the pool of providers the savings plan is beneficial to the providers because the plan functions as a referral service for medical and other professionals that generates inquiries from consumers who would otherwise not contact a particular provider for any number of reasons: uninsured consumers may tend to avoid or minimize consumption of health care services, some consumers may assume that health care services are available only at prices not affordable to him or her, and if these consumers were made aware of discounted prices or fees offered by providers on a referral list those consumers would more frequently use such services. Some consumers may not know that a health care provider was conveniently located, and learns this information only by accessing a referral service list of health care providers and their locations. The fact that a savings plan organizes professionals by specialty and location may enhance the appeal of using the health care services, and stimulate consumption of health care services that would otherwise not occur. The publication of sample discounted prices may galvanize the consumer to use health care providers not otherwise being sought.

Other referral services, however, typically operate by charging a monthly fee.

Because the casual or occasional consumer of services has an imperfect knowledge of a complex marketplace, merely quoting a reduced or discounted price to the consumer does not make apparent an extent of savings. Therefore it is desirable for a consumer to have access to a health care savings plan which notifies consumers of discounts in a way that has the maximum impact—initially upon selection of the provider, and later at the time of billing. The prior art plans do not have the combined advantages of laying out for the consumer the amount saved through discounts and providing a preferred price for participation in a plan, yet not incurring a regular recurrent charge for plan participation. Furthermore, it is preferable to not require prior participation in an insurance program or affiliation with any organization such as an employer or a health maintenance organization since many health care consumers might not be affiliated with such organizations.

Another problem encountered by health care consumers is the fact that patients consume many different prescription and non-prescription medications on a regular basis. It is important to know the prescription medications being taken in order to consider synergistic effects of new medication on existing medication. For this reason and perhaps other medical reasons, virtually every time a patient enters a hospital or sees a physician, a health care provider asks the patient what medication they are taking currently in order to make use of this critical information in the patient's health care. Often, the patient does not have ready access to such information to be able to provide it to the health care provider. Recall that older individuals especially consume many different prescription medications on a daily basis. How many people remember their exact regimen of medications, including dosages, identity of prescribing physicians, chemical and brand name etc.?

Although portable tracking systems for such information have been proposed, see for example the Medication Monitoring System and Apparatus of U.S. Pat. No. 6,421,650 B1, the information is not controlled by a neutral third party at a central location in such a way that allows the information to be automatically available to all relevant parties who need it. Furthermore, such access to the information is not part and parcel of a health savings plan. Health insurers do not always grant approval of a medical treatment; health maintenance organizations may want to reduce the treatment types of health care services consumed in order to reduce expenses. Since insurance companies and health maintenance organizations have differing interests from patients with regard to providing health care services to the patients, they are not the best parties to control collecting and granting access to information about prescription medications taken by a patient, which information forms the patient's prescription profile in a database.

There is thus a need for a medical savings plan that alerts the user to the savings as the savings accrues. There is a need for such a plan that does so as part of its billing process. There is also a need for such a savings plan in which a database of patient prescription medications is accumulated as the health care consumer uses the plan and in which the health care consumer and health care provider have ready access to such information and in which access to such a database is maintained by a neutral third party at a central location.

### OBJECTS AND ADVANTAGES

The following important objects and advantages of the present invention are:

(1) to provide a method of operating a medical savings plan that includes the creation, and the updating when health care services are consumed, of a database of prescription patient medication, the database maintained by the owner of the health savings plan at a central location wherein the plan owner is interested in accumulating all information useful to prescription medications consumed by the patient through the plan in a single updatable database;

(2) to provide a method as described wherein the database maintained by a data source provides to a health care service consumer or a health care provider a reliable list of all prescription medication purchased and taken by the patient through the plan since enrollment in the program or within the last six or twelve months and wherein the list includes the medication's chemical and brand name, dosage, date and place of purchase, the identity of the prescribing provider and the date the medication was taken

(3) to provide a method of operating a medical savings plan that makes available to consumers of services encompassed by the plan a full range of networks of providers, including physicians, dentists, optometrists, opticians, pharmacists and ancillary medical care personnel;

(4) to provide a medical savings plan that affords discounts to the consumers wherein these discounts represent a substantial savings off the regular prices of participating providers;

(5) to provide such a plan wherein the plan owner charges no monthly fee for participation in the plan and no other fees except an administrative fee representing a specified percentage of the savings;

(6) to provide such a plan whereby the administrative fee is between approximately 25% and approximately 33% of the savings, which discount is also called the savings difference;

(7) to provide a health care savings plan wherein the discount is highlighted to the user at the time of billing since the user is billed separately for the health care services at the regular price, wherein the user is also credited an amount representing a discount off the regular price less the approximately 25% to 33% administrative fee representing a specified percentage of the savings difference and a bank charge if applicable;

(8) to provide a medical savings plan whereby the amount of the savings is highlighted to the user as part of the billing process of the plan;

(9) to provide a medical savings plan that is useful and convenient both for the uninsured consumer and the insured consumer and both for employed and unemployed consumers; and

(10) to provide a medical savings plan that allows a health care provider to submit a claim while the health care consumer is in the office of the provider so that approval authorization on the credit card is determined on the spot and if there is a rejection the provider can use alternate means of billing.

### SUMMARY OF THE INVENTION

A method of operating a health care services savings plan is disclosed wherein it is not necessary to charge a monthly fee. Individual health care providers or provider entities are approached and identified and asked to furnish an agreement to accord very substantial discounts to participating consumers, and to also furnish basic identifying data about themselves to be available to the public. An individual provider or individual health care provider in this context is understood to be an individual practitioner or service provider, whereas a provider entity or health care provider entity is understood to be a organization such as a partnership, an LLC, or a corporation which is empowered to offer the services of at least two individual providers. When a provider entity participates in the plan, the form of this participation may either take the form of furnishing of a list of individual providers, the provider entity being invisible to the consumer, or of a listing of the provider entity as itself in the form of an individual provider: for example, “Park West Medical Associates”, a discounted price for a procedure performed at that location being associated with the collective entity, but not with an particular individual practitioner. The terms “provider” or “health care provider” or “health care service provider” when not otherwise qualified shall be understood to refer indifferently to an individual provider or a provider entity.

The data on these individual providers or provider entities is made available by any of several methods, one being that the data is entered in and published on the plan owner's advertised web site. The web site identifies the individual health care providers or provider entities for each medical specialty as well as the percentage of such discount or savings that the consumer is asked to return as an administrative charge to the plan owner and in certain alternative embodiments the web site also identifies an overall estimate of the amount of discount the consumer can expect to receive off the regular prices charged by comparable providers in that geographic area for health care treatments in general under the plan. Data is updated as changes occur. Consumers electing to participate in the plan are issued cards by the plan owner. Participating consumers access the data, select health care providers or provider entities, present plan cards to the selected providers and receive health care.

During the course of receiving health care services the consumer tells the health care provider to access the patient prescription profile database to see what prescription medication purchased through the plan he or she has taken within the last “X” number of months. Alternatively, the consumer obtains this information from the database of the plan and notifies the health care provider of the prescription medication information obtained from the database. Such information has accumulated on the database because on each previous occasion that prescription medication had been dispensed to that consumer by a pharmacy in the network of the plan—while the consumer was a member of the plan—the prescription medication data had been entered in a patient prescription profile database maintained by the pharmacy benefit manager of the plan. The database will be updated to include any new prescription medication required by the health care provider for new treatment that the consumer now needs once the consumer has such new medication dispensed at a pharmacy in the network of the plan. This database is accessible by any health care provider who is a member of the plan after entering an authorization code. The data is also accessible to the patient.

In accordance with certain embodiments of the present invention, since the consumer may remember certain portions of the prescription medication information at the time he or she enters the plan, there can be provisions for the plan to enter such information manually, however incomplete, into the database all at once to create a new profile before the patient goes to the pharmacy under the plan. For example, such information could be entered by the pharmacy benefit manager when the consumer joins the plan as part of the application process.

The plan bills the user the regular price, issues a credit for the savings difference less the administrative charge representing the previously published specified percentage of the savings difference. That percentage is twenty-five to thirty percent (25% to 33%) of the savings difference. In a preferred embodiment, the billing is conducted electronically and begins when the health care provider first bills the plan for the visit of the consumer by telecommunications using a computer, whereupon the plan electronically bills the health care consumer's credit card.

### DETAILED DESCRIPTION OF THE PREFERRED EMBODIMENT

The present method involves the operation of a health care savings plan without a monthly fee, by a plan owner which is a company or other entity that administers the savings plan. The consumers of the health care services typically make payments by credit cards. To the extent payments are made by credit card, the plan owner is in the position of a vendor in relation to the credit card company of the consumer.

The services provided under the plan are not limited to medical care but rather also include dental services, purchasing of pharmacy prescriptions, and optical services such as optometrists and opticians, and diagnostic laboratories. The plan can include other health related services also, such as nursing, as well as almost every form of health related services.. With respect to prescriptions, instead of treatment types the services would be categorized by types of medication. Accordingly, the term “provider” or “health care provider” or “health care service(s) provider” as used herein means physicians, dentists, pharmacists, optometrist, opticians and ancillary medical care personnel such as hospital home care personnel but can also mean other types of health care providers. An individual provider or individual health care provider in this context is understood to be an individual practitioner or service provider, whereas a provider entity or health care provider entity is understood to be a organization such as a partnership, an LLC, or a corporation which is empowered to offer the services of at least two individual providers. When a provider entity participates in the plan, the form of this participation may either take the form of furnishing of a list of individual providers, the provider entity being invisible to the consumer, or of a listing of the provider entity as itself in the form of an individual provider: for example, “Park West Medical Associates”, a discounted price for a procedure performed at that location being associated with the collective entity, but not with an particular individual practitioner. When a health care provider entity furnishes a plan owner with information for individual providers or practitioners, these providers or practitioners will be referred to as being under the administrative control of the health care provider entity. The terms “provider” or “health care provider” or “health care service provider” when not otherwise qualified shall be understood to refer indifferently to an individual provider or a provider entity. The term “pharmacist” as used herein can mean a major chain drug store as well as a neighborhood pharmacy.

The plan operates as follows:

The plan is first configured to include a plurality of health care service providers or provider entities who have mutually agreed to participate in the plan by providing medical services, dental services, pharmacy services, optometry services, etc. at a very substantial discount, which discounted prices are agreed to in advance and are uniform for specified services in a given geographic area. The plan owner, after deciding which geographic area it wishes to operate in, identifies and approaches providers in all or enough specialties for each area to cover all or substantially all of the expected forms of treatment and medication types needed by patients. The services offered have to be sufficiently broad in scope to attract and maintain a sufficient pool of participating consumers, which in turn attracts and maintains a pool of participating providers. The treatment types can be categorized in a number of ways, one of which being simply using the categories that insurance companies use to categorize treatment types. For each treatment type specified the individual provider or provider entity is asked to agree to provide a specified health care service at a specified discounted price. The term “health care services” including dental care services, optometry services and other health care services normally provided by “health care service providers” as that term is defined herein. Although with respect to pharmacists, instead of treatment types, it is really types of medication that is being provided, the term “treatment type” as used herein shall be intended to include the provision of types of medication normally provided by pharmacists.

Nationwide (and the same may hold true within a particular geographic area.) some providers have agreed to one of two things in regard to price—that they receive a specified discounted flat fee (price) for a particular treatment or that they receive a specified percentage off their regular price for a particular treatment. The providers that receive the flat fee may receive more or less of a percentage discount from their regular price than the specified percentage received by the other providers who have agreed to take a specified percentage off their regular price.

The price offered by all providers to consumers under the plan is uniform for a particular treatment type, although in an alternative embodiment, the price is not uniform. As an example where the price is uniform, the price for a mammography would be uniform across the board for all providers participating in the plan. In an alternative embodiment, the uniformity would be limited to a particular geographic area. It should be noted, however, that the regular price that the various providers in that medical specialty offer such a treatment type in all likelihood varies. Since the actual discounted price offered under the plan is uniform for plan providers, the amount of the percentage discount off the regular price offered by the plan varies in relation to the particular provider.

It should be noted that in the invoice from the plan to the health care consumer the cost of the “treatment type” also include the cost of the laboratory tests requisitioned by the health care provider as part of the treatment whereas in the invoice from the health care provider to the plan the cost of the laboratory test would not appear. The laboratory test would be invoiced to the plan separately from the laboratory and would be treated a separate “treatment” or “treatment type”.

Each of the providers or provider entities in the plurality of health care providers participating in the plan agrees to sign a uniform provider agreement that states a specific discounted price for the various treatment types and medication types and obligates the individual health care providers or provider entities to provide basic identification information, such as name, address, telephone number, that will be made available to consumers by one of various methods including (i) on a web site connected to a global communications network such as the World Wide Web on the Internet and (ii) by means of a live operator having access to a computerized locator. In the alternative embodiment where the prices are not uniform for a particular treatment type, the uniform provider agreement would not state a specific discounted price that is uniform. The provider entities may either sign agreements which obligate them to supply basic identification information of individual providers whom they are empowered to contract for, or of the provider entity or service center itself.

Once the plan is configured, the plan owner advertises the plan to create a pool of patients who would participate in the plan by consuming the health care services of the health care providers who participate in the plan. The advertisement includes reference to a web site of the plan owner where basic data about participating health care providers is listed by medical specialty and geographic location.

The plan owner enters data and publishes that data in one of several ways. In the preferred embodiment, the data is entered and published on a web site connected to and accessible through a global communications network. The web site includes (i) the identification data provided by the health care providers, (ii) the savings available for sample treatments and medication types under the plan, (iii) a specific example of a billing of health care service under the plan showing the regular price for a particular health care service, the discounted price for that health care service, a savings difference saved under the plan, a service fee percentage, and an administrative charge debit charged by the plan, calculated by applying the service fee percentage to the savings difference, the specific examples serving to highlight how a consumer who uses the plan saves the savings difference less the administrative charge debit, and (iv) an invitation to order a membership enrollment form and to join the plan. The web site is operated and supported by a computer of the plan owner, or by an Internet service provider who leases disk storage and web access to the plan owner. The administrative charge debit is arrived at by applying a service fee percentage to the savings difference and that service fee percentage is also stated on the web site as always being between 25% and 33%.

The web site specifies the savings available for various treatment by giving examples of price discounts for particular treatment and medication types and by illustrating how the whole savings is retained by the consumer except for the administrative charge which in each example represents a specified percentage—the service fee percentage—of the savings difference. The service fee percentage is between 25% and 33%. The web site also explains that there is no monthly fee, no premiums, no other fees, no co-payments and no claim forms, and invites interested consumers to order a membership enrollment form.

Medication types are not specified by example on the web site because unlike treatments there are no published average costs for medication types

In the alternative embodiment, the data is entered and published on a computer and is access by a live operator who is contacted by a health care consumer, for example by telephone. Accordingly, the term “entering and publishing” as used herein shall include entering the data on a computer and making it available to consumers who call in to a live operator who accesses such data. The term “data source” as used herein shall mean either a web site connected to and accessible through a global communications network or else a computer run by a human operator who can be contacted and requested orally to electronically search and retrieve data on the computer and respond to the request from a health care consumer.

An illustration of an example is provided below. The examples is of the billing of a visit for an abdominal MRI under the plan. The regular price ($1200) and the discounted price ($400) for that treatment type is listed and it is calculated that the consumer saves 66.67% ($800) by using the plan at the discounted price. It is further shown by the example that the consumer retains the full 66.67% savings difference ($800) less 25% ($200) of that 80%. In the example provided, the consumer saves $600, which represents a net savings of 50 percent.

When a consumer communicates to the plan owner that he or she wishes to enroll in the savings plan, a membership enrollment form is electronically transmitted over the World Wide Web or otherwise provided to them such as by asking questions over the telephone. The membership enrollment form in certain embodiments notifies the consumers that they can call up to learn of a specific actual price for a specific treatment or medication type, although any such price would not include ancillary costs like x-rays, laboratory tests, etc. Accordingly, the consumer can get some idea in advance how much of a savings he or she will obtain. The absence of monthly or other fees allows the consumer to better calculate the expected cost savings since it is independent of the number of visits. If the visits increase then the savings increases proportionately so the proportion of the savings can be predicted. The membership enrollment form also includes a health care savings plan card for health care consumers who have agreed to participate in the plan. The web site also explains that there are no monthly charges for use of the plan and that the only charge is a fixed service fee percentage ranging from 25 to 33 percent of the actual savings difference realized by the consumer.

As explained further below, the billing method further highlights to the consumer the realization of the savings. The web site publishes the service fee percentage charged by the plan, which represents the proportion of the savings difference, i.e. 25% or 33% of that difference that is charged by the plan as an administrative charge. The terms “savings difference” means the difference between the regular price of the provider for a particular treatment or medication type and the actual discounted price paid under the plan.

Once the plan has been configured, data provided by the health care provider entities is entered and published to consumers on a web site connected to and accessible through a global communications network such as the Internet. The web site is operated and supported by a computer of the plan or that of an Internet service provider from whom the plan owner leases disk storage and Internet access. A leased or partially leased computer will also be referred to hereunder as a “computer of the plan”. The data on the web site, including identification data applicable to the providers and including prices, is updated regularly as new providers are added to the pool of providers and as the data changes with respect to existing providers. Furthermore, if the participation status of any of the health care provider entities changes that information is also updated on the web site when it occurs.

Once the consumer receives the health care savings plan card, the consumer goes to the provider and obtains any needed health care service, whether it be medical, dental, optical (optometrist or optician) or pharmacy. For each instance in which there is a provision of health care services by an individual provider or health care providing entity participating in the plan to a consumer of the health care services who is enrolled in the plan, the plan is implemented as follows:

(a) the health care consumer accesses the data and selects an individual provider or health care provider entity or, if the pool of providers is sufficiently large, inquires from a provider the consumer already knows as to whether the provider is a member of the plan and if applicable is told that the provider participates in the plan;

(b) the health care consumer goes to the provider and presents a health care savings plan card evidencing membership in the plan. After presenting the card, the provider requests an authorization number from the plan. Upon receipt and verification, the consumer receives a treatment type of health care services from that health care provider. Non-participants do not receive the discount offered under the plan from the provider who is a member of the plan.

(c) upon a prescription medication being prescribed by the selected health care provider as part of the treatment type of health care services and upon such prescription medication being later dispensed by a pharmacy within a network of the plan, prescription medication information concerning such prescription medication is entered into a patient profile prescription database maintained by the data source. The selected health care provider thus has access to all prescription medication information that has previously been entered into the patient profile prescription database.

(d) the health care provider electronically transmits an invoice for its treatment type of health care services to the computer of the plan for the treatment or medication type of health care services provided to the health care consumer;

It should be noted that while the health care consumer is at the office of the health care provider the health care provider electronically transmits the claim for health care services provided by the health care provider to the computer of the plan owner for the treatment type. The claim includes a provider identification number, a member identification number, a date of service, a procedure code for the treatment type and an amount of the regular price of the health care provider for the treatment type. The computer of the plan owner has a database its storage and the database includes data concerning health care consumers, health care providers and fee schedules.

The patient profile prescription database accumulates data concerning what prescription medication each health care consumer is taking each time the health care consumer is prescribed new prescription medication and such medication is dispensed by a pharmacy in the network of the plan. This data includes the chemical name and the brand name of the prescription medication, the identity of the drugstore where such prescription medication was purchased, the dosage called for, the dates of purchase and the dates of consumption of the prescription medication, and the identity and telephone number of the health care provider who prescribed the medication. The prescription patient profile database is maintained by the data source—it is maintained at the web site or is stored on the computer accessed by the human operator. Thus the plan's database provides a certified list of all prescription medication taken by the patient within the last six to twelve months. Besides the comprehensiveness and accessibility, this information is also more valuable than a slapped-together list provided by the patient of what he or she remembers.

Each time the health care consumer who is a member of the health care savings plan sees a health care provider under the plan, the health care provider can access the patient profile prescription database either by calling a telephone number of the plan owner and giving an authorization code to a human being that then accesses the patient prescription profile database an and faxes a list of prescription medications with the other parts of the data for that health care consumer to the health care provider and/or the health care provider has a computer that calls the plan owner and after entering an authorization code access the part of the patient prescription profile database pertaining that that health care consumer to see the relevant data and have the computer print it out. Furthermore, the health care consumer can also access the portion of the patient prescription profile database relating to that consumer.

Subsequently, the computer of the plan owner searches the database of credit card data for the health care consumer to determine if the credit card account of the health care consumer has in it an amount at least equal to the regular price of the health care provider for the treatment type. If the computer's determination is that it does, the computer calculates the savings difference, the amount of the credit and the amount of the administrative charge debit and then issues an authorization number to the health care provider approving the transaction. If not, the computer advises the health care provider so that the health care provider, who has the health care consumer in his or her office, can request payment of the usual and customary fee instead by cash.

(e) the plan owner electronically transmits a debit to the credit card company of the consumer on the consumer's account for the treatment type of health care services at the regular price,

(f) the plan electronically transmits a credit to the credit card company of the health care consumer on the consumer's account. The credit represents a savings difference between the regular price for that treatment type of health care services and the discounted price for that treatment type of health care services which is then reduced by an administration charge debit to the credit card company of the health care consumer, the administrative charge debit representing the service fee percentage applied by the plan owner to the savings difference. The administrative charge debit is always between 25% and 33% of the savings difference;

(g) the health care consumer pays to the credit card company the sum of the debit less the credit (the credit already includes the administrative charge debit) plus any applicable credit card fee,

(h) the credit card company pays the plan owner the sum of the debit less the credit; and

(i) the plan pays the health care provider entity the discounted price for the treatment type of health care services and retains the amount equal to the administrative charge debt less the credit card fee.

It can be seen that under the health care savings plan shown herein, the consumer pays no monthly or other fee and that the only fee paid is proportional to the consumer's use of the plan. Furthermore, it can be seen that under the plan shown herein, the fact and amount of the savings realized by the consumer is highlighted to the consumer both at the time of joining the plan and during use of the plan and after use of the plan through the billing method described.

The method described above differs with respect to the pharmacist first of all in that the pharmacist is selling goods rather than providing a health care service. However, for simplicity in this patent application the term “health care services” shall also include what the pharmacist does in providing to health care consumers prescription medication. Instead of a treatment type there is a medication type. As previously noted, the medication type does not have a standard regular price. Accordingly, no specific example of the savings on a particular kind of prescription medication is provided in advance to the health care consumer.

The savings plan of the present invention can also operate in conjunction with health insurance reimbursement of the health care services consumed under the plan. After payment by the health care consumer the insurance company can reimburse the health care consumer. Before payment, the insurance company can stand in the shoes of the health care consumer when making payment.

It is to be understood that while the method of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof It is not desired to limit the invention to the exact construction and operation shown and described. The spirit and scope of this invention are limited only by the spirit and scope of the following claims.

What is claimed is:

1. A method of operating a health care savings plan without a monthly fee by a plan owner that acts as a vendor in relation to a credit card company, comprising:
configuring the plan to serve a plurality of health care service providers who have mutually agreed to participate in the plan by providing health care services at either a specified discounted price for specified services or at a specified percentage off their regular price for specified services, have agreed to sign a respective plurality of provider agreements that state the amount of the specified discounted price or specified percentage off for the specified services and have agreed to provide identification data either in their own right as health care providers or for individual health care providers under their administrative control, which identification data will be made available to health care consumers;
entering and publishing on a data source (i) the identification data provided by the health care providers (ii) that the savings are available for various treatment and medication types under the plan, (iii) a specific example of a billing of health care service under the plan showing the regular price for a particular health care service, the discounted price for that health care service, a savings difference saved under the plan, a service fee percentage, an administrative charge debit charged by the plan calculated by applying the service fee percentage to the savings difference, the specific examples serving to highlight how a consumer who uses the plan saves the savings difference less the administrative charge debit, (iv) a statement asserting an absence of any monthly fees, premiums, co-payments or claim forms, and (v) a membership enrollment form to join the plan, said data source operated and supported by a computer of the plan, said administrative charge debit arrived at by applying a service fee percentage to the savings difference;
updating the data as changes in a status of any of the plurality of health care providers occur,
issuing a health care savings plan card to each health care consumer who has agreed to participate in the plan; and
implementing the plan so that for each provision of health care services,
(a) a health care consumer accesses the data and selects a health care provider;
(b) the health care consumer presents a health care savings plan card to the selected health care provider and receives a treatment type of health care services from that health care provider;
(c) upon a prescription medication being prescribed by the selected health care provider as part of the treatment type of health care services and upon such prescription medication being later dispensed by a pharmacy within a network of the plan, prescription medication information concerning such prescription medication is entered into a patient profile prescription database maintained by the data source, the selected health care provider having access to all prescription medication information that has been entered into the patient profile prescription database;
(d) the health care provider electronically transmits an invoice for health care services provided by the health care provider to the computer of the plan owner for the treatment type of health care services provided to the health care consumer;
(e) the plan owner electronically transmits a debit to the credit card company of the health care consumer for the treatment type of health care services at the regular price;
(f) the plan owner electronically transmits a credit to the credit card company of the health care consumer, said credit representing a savings difference minus an administrative charge debit to the credit card company of the health care consumer, said saving difference being a difference between the regular price for said treatment type of health care services and the discounted price for said treatment type of health care services, said administrative charge debit representing a service fee percentage applied by the plan owner to the savings difference;
(g) the health care consumer pays to the credit card company a sum equal to the debit less the credit, plus any credit card fee that is applicable;
(h) the credit card company pays to the plan owner the sum of the debit less the credit, and
(i) the plan owner pays the health care provider entity the discounted price for said health care services and retains the administrative charge debit.

2. The method of claim 1, wherein the data source is a web site connected to and accessible by a health care consumer and by a health care provider through a global communications network.

3. The method of claim 1, wherein the data source is a computer operated by a human who upon oral request from a health care consumer or a health care provider searches and retrieves data from said data source and provides said data to the health care consumer or health care provider.

4. The method of claim 2, wherein a pool of health care service providers participating in the plan includes physicians, dentists, optometrists, opticians and ancillary medical care personnel.

5. The method of claim 4, wherein prescription medication information includes a chemical name of a prescription medication, a brand name of the prescription medication, an identity of a pharmacy where the prescription medication was purchased by the health care consumer, a dosage of the prescription medication and a purchase date and consumption dates for the prescription medication.

6. The method of claim 2, wherein for health care service providers who are pharmacists the step of entering and publishing does not include a specific example of a billing of health care service under the plan.

7. The method of claim 2, wherein the service fee percentage is between approximately 25% and approximately 33%.

8. The method of claim 1, wherein the service fee percentage is between approximately 25% and approximately 33%.

9. The method of claim 1, wherein the pharmacy benefit manager of the plan enters certain prescription medication information recalled by the health care consumer manually to begin the patient profile prescription database when the consumer joins the plan as part of an application process.

10. A method of operating a health care savings plan without a monthly fee by a plan owner that acts as a vendor in relation to a credit card company, comprising:
configuring the plan to serve a plurality of health care service providers who have mutually agreed to participate in the plan by providing health care services at either a specified discounted price for specified services or at a specified percentage off their regular price for specified services, have agreed to sign a respective plurality of provider agreements that state the amount of the specified discounted price or specified percentage off for the specified services and have agreed to provide identification data either in their own right as health care providers or for individual health care providers under their administrative control, which identification data will be made available to health care consumers;
entering and publishing on a web site connected to and accessible through a global communications network (i) the identification data provided by the health care providers (ii) the savings available for various treatment and medication types under the plan, (iii) a specific example of a billing of health care service under the plan showing the regular price for a particular health care service, the discounted price for that health care service, a savings difference saved under the plan, a service fee percentage, an administrative charge debit charged by the plan calculated by applying the service fee percentage to the savings difference, the specific examples serving to highlight how a consumer who uses the plan saves the savings difference less the administrative charge debit, (iv) a statement asserting an absence of any monthly fees, premiums, co-payments or claim forms, and (v) a membership enrollment form to join the plan, said web site operated and supported by a computer of the plan, said administrative charge debit arrived at by applying a service fee percentage to the savings difference;
updating the data as changes in a status of any of the plurality of health care providers occur,
issuing a health care savings plan card to each health care consumer who has agreed to participate in the plan; and
implementing the plan so that for each provision of health care services,
(a) a health care consumer accesses the data and selects a health care provider;
(b) the health care consumer presents a health care savings plan card to the selected health care provider and receives a treatment type of health care services from that health care provider;
(c) upon a prescription medication being prescribed by the selected health care provider as part of the treatment type of health care services and upon such prescription medication being later dispensed by a pharmacy within a network of the plan, prescription medication information concerning such prescription medication is entered into a patient profile prescription database maintained by the data source, the selected health care provider having access to all prescription medication information that has been entered into the patient profile prescription database;
(d) while the health care consumer is at the office of the health care provider the health care provider electronically transmits an invoice for health care services provided by the health care provider to the computer of the plan owner for the treatment type of health care services provided to the health care consumer; said invoice including a provider identification number, a member identification number, a date of service, a procedure code for the treatment type and an amount of the regular price of the health care provider for the treatment type, said computer of the plan owner having stored therein a database including data concerning health care consumers, health care providers and fee schedules,
(e) the computer of the plan owner searches a database of credit card data for the health care consumer to determine if a credit card account of the health care consumer has in it an amount at least equal to the regular price of the health care provider for the treatment type, wherein if the determination is affirmative the computer, calculates a savings difference, a credit, and an administrative charge debit and issues an authorization number to the health care provider and if the determination is negative the computer advises the health care provider so that the health care provider can request payment of its regular fee by cash,
(f) the plan owner electronically transmits a debit to the credit card company of the health care consumer for the treatment type of health care services at the regular price;
(g) the plan owner electronically transmits a credit to the credit card company of the health care consumer, said credit representing a savings difference minus an administrative charge debit to the credit card company of the health care consumer, said saving difference being a difference between the regular price for said treatment type of health care services and the discounted price for said treatment type of health care services, said administrative charge debit representing a service fee percentage applied by the plan owner to the savings difference;
(h) the health care consumer pays to the credit card company a sum equal to the debit less the credit, plus any credit card fee that is applicable;
(i) the credit card company pays to the plan owner the sum of the debit less the credit; and
(j) the plan owner pays the health care provider entity the discounted price for said treatment type of health care services and retains the administrative charge debit.

11. The method of claim 10, wherein the data source is a web site connected to and accessible by a health care consumer and by a health care provider through a global communications network.

12. The method of claim 10, wherein the data source is a computer operated by a human who upon oral request from a health care consumer or a health care provider searches and retrieves data from said data source and provides said data to the health care consumer or health care provider.

13. The method of claim 11, wherein a pool of health care service providers participating in the plan includes physicians, dentists, optometrists, opticians and ancillary medical care personnel.

14. The method of claim 13, wherein prescription medication information includes a chemical name of a prescription medication, a brand name of the prescription medication, an identity of a pharmacy where the prescription medication was purchased by the health care consumer, a dosage of the prescription medication and a purchase date and consumption dates for the prescription medication.

15. The method of claim 11, wherein for health care service providers who are pharmacists the step of entering and publishing does not include a specific example of a billing of health care service under the plan.

16. The method of claim 11, wherein the service fee percentage is between approximately 25% and approximately 33%.

17. The method of claim 10, wherein the service fee percentage is between approximately 25% and approximately 33%.

18. The method of claim 10, wherein the pharmacy benefit manager of the plan enters certain prescription medication information recalled by the health care consumer manually to begin the patient profile prescription database when the consumer joins the plan as part of an application process.
